(19) United States
(12) Patent Application Publication
(10) Pub. No.: US 2024/0055769 A1
(43) Pub. Date: Feb. 15, 2024

(54) SLOT ANTENNA STRUCTURE AND ELECTRONIC DEVICE

(71) Applicant: Wistron NeWeb Corporation, Hsinchu (TW)

(72) Inventors: Kuan-Yi LI, Hsinchu (TW); Cheng-Wei CHANG, Hsinchu (TW)

(21) Appl. No.: 18/333,585

(22) Filed: Jun. 13, 2023

(30) Foreign Application Priority Data
Aug. 9, 2022 (TW) 111129879

(51) Int. Cl. H01Q 13/10; H01Q 5/50

(52) U.S. Cl. CPC H01Q 13/10; H01Q 5/50

(57) ABSTRACT

A slot antenna structure includes an antenna unit and a metal unit. The metal unit is electrically connected to the antenna unit and includes a first slot, a second slot, and a third slot. The first slot has a first length along a direction. The second slot is spaced a first distance apart from the first slot and has a second length along the direction. The third slot is spaced a second distance apart from the second slot and has a third length along the direction. The first slot, the second slot, and the third slot are arranged in sequence along the direction. The first length is greater than the second length, and the third length is greater than the first length.

### CROSS-REFERENCE TO RELATED PATENT APPLICATION

This application claims the benefit of priority to Taiwan Patent Application No. 111129879, filed on Aug. 9, 2022. The entire content of the above identified application is incorporated herein by reference.

### BACKGROUND

### Technical Field

The present disclosure relates to an antenna structure and an electronic device, and more particularly, to a slot antenna structure and an electronic device having the slot antenna structure.

### Description of Related Art

With the increasing demand for wireless transmission, general laptop computers or other mobile devices are equipped with antennas for transmitting and receiving data wirelessly. However, with the development of mobile devices heading toward a thin-and-light trend, the size of antenna components in mobile devices must also be reduced.

From this, developing a slot antenna structure with increased antenna bandwidth at reduced size and an electronic device having such slot antenna structure is a goal in the related industry.

### SUMMARY

It is an aspect of the present disclosure to provide a slot antenna structure that includes an antenna unit and a metal unit. The metal unit is electrically connected to the antenna unit and includes a first slot, a second slot, and a third slot. The first slot has a first length along a direction. The second slot has a second length along the direction and is spaced a first distance apart from the first slot. The third slot has a third length along the direction and is spaced a second distance apart from the second slot. The first slot, the second slot, and the third slot are arranged along the direction in sequence. The first length is greater than the second length, and the third length is greater than the first length.

It is another aspect of the present disclosure to provide a slot antenna structure that includes an antenna unit and a metal unit. The metal unit is electrically connected to the antenna unit and includes a first slot, a second slot, and a third slot. The first slot has a first length along a direction. The second slot has a second length along the direction and is spaced a first distance apart from the first slot. The third slot has a third length along the direction and is spaced a second distance apart from the second slot. The first slot, the second slot, and the third slot are arranged along the direction in sequence. Any one of the first slot, the second slot, and the third slot is a closed slot, and the first length, the second length, and the third length are different.

It is yet another aspect of the present disclosure to provide an electronic device that includes a housing and a slot antenna structure. The slot antenna structure is disposed in the housing and includes an antenna unit and a metal unit. The metal unit is electrically connected to the antenna unit and includes a first slot, a second slot, and a third slot. The first slot has a first length along a direction. The second slot has a second length along the direction and is spaced a first distance apart from the first slot. The third slot has a third length along the direction and is spaced a second distance apart from the second slot. The first slot, the second slot, and the third slot are arranged along the direction in sequence, and any one of the first slot, the second slot, and the third slot is a closed slot. The first length is greater than the second length, and the third length is greater than the first length.

### BRIEF DESCRIPTION OF THE DRAWINGS

The present disclosure can be more fully understood by reading the following detailed description of the embodiment, with reference made to the accompanying drawings as follows:

FIG. 1 is a schematic view of a slot antenna structure according to a first embodiment of the present disclosure.

FIG. 2 is a voltage standing wave ratio (VSWR) graph of the slot antenna structure shown in FIG. 1.

FIG. 3 is a schematic graph illustrating an efficiency of the slot antenna structure shown in FIG. 1.

FIG. 4 is a schematic view of an electronic device according to a second embodiment of the present disclosure.

### DETAILED DESCRIPTION

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

In the present disclosure, when an element (i.e. a unit or a module) is described to “connect” to another element, it means to that the element is directly connected to the other element, or that certain element is indirectly connected to the other element, which implies that there is another element between the element and the other element. When an element is described to “directly connect” to another element, it means to no other element is between the element and the other element.

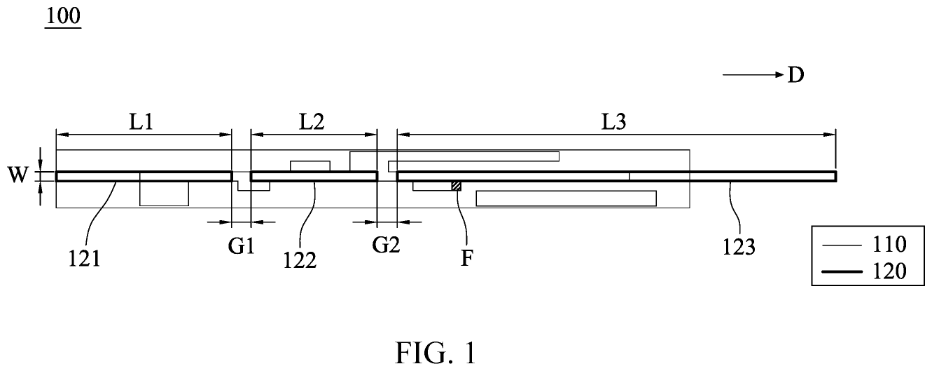

Referring to FIG. 1, FIG. 1 is a schematic view of a slot antenna structure 100 according to a first embodiment of the present disclosure. The slot antenna structure 100 includes an antenna unit 110 and a metal unit 120. The metal unit 120 is electrically connected to the antenna unit 110 and includes a first slot 121, a second slot 122 and a third slot 123. The first slot 121 has a first length L1 along a direction D. The second slot 122 is spaced a first distance G1 apart from the first slot 121 and has a second length L2 along the direction D. The third slot 123 is spaced a second distance G2 apart from the second slot 122 and has a third length L3 along the direction D. The first slot 121, the second slot 122, and the third slot 123 are arranged along the direction D in sequence. The first length L1 is greater than the second length L2, and the third length L3 is greater than the first length L1.

Moreover, the slot antenna structure 100 can further include a feeding point F disposed on the antenna unit 110. The position of the feeding point F corresponds to the third slot 123, in other words, the position of the feeding point F is relatively closer to the third slot 123 than to the first slot 121 or the second slot 122. In one embodiment, the feeding point F is adjacent to the third slot 123 as shown in FIG. 1, and in other embodiments, there is a gap between the feeding point F and the third slot 123. In specific, an antenna signal is fed to the antenna unit 110 through the feeding point F and resonates with the first slot 121, the second slot 122 and/or the third slot 123 to generate transmission signal. Alternatively, the antenna signal resonates at where the metal unit 120 is bent for the formation of the first slot 121, the second slot 122, and the third slot 123.

Thus, the slot antenna structure 100 of the present disclosure uses three slots, namely the first slot 121, the second slot 122, and the third slot 123, to excite transmission signals in multiple frequency bands.

More specifically, the first distance G1 and the second distance G2 can be both greater than or equal to 1 mm and less than or equal to 3 mm. The first length L1 can be greater than or equal to 16 mm and less than or equal to 20 mm. The second length L2 can be greater than or equal to 11 mm and less than or equal to 15 mm. The third length L3 can be greater than or equal to 43 mm and less than or equal to 47 mm. The width W of the first slot 121, the width W of the second slot 122, and the width W of the third slot 123 can be all less than 2 mm. The sum of the first length L1, the second length L2, the third length L3, the first distance G1 and the second distance G2 can be less than or equal to 84 mm. In this embodiment, the first distance G1 and the second distance G2 are both 2 mm, the first length L1 is 18 mm, the second length L2 is 13 mm, the third length L3 is 45 mm, the width W of the first slot 121, the width W of the second slot 122, and the width W of the third slot 123 are all 1 mm, and the sum of the first length L1, the second length L2, the third length L3, the first distance G1, and the second distance G2 is 80 mm, but the present disclosure is not limited thereto. In this embodiment, the shape and pattern of the antenna unit 110 is as shown in FIG. 1, but the present disclosure is not limited thereby. Hence, the slot antenna structure 100 of the present disclosure reduces the widths W of the slots to 1 mm and shortens the length of the metal unit 120, which is the sum of the first length L1, the second length L2, the third length L3, the first distance G1, and the second distance G2, to 80 mm, and so is able to excite transmission signals in multiple frequency bands while the overall size of the slot antenna 100 has been decreased.

In other embodiments of the present disclosure, any one of the first slot 121, the second slot 122 and the third slot 123 is a closed slot. The first length L1 of the first slot 121, the second length L2 of the second slot 122, and the third length L3 of the third slot 123 are different. In other words, the first slot 121, the second slot 122, and the third slot 123 can be all closed slots, and the first length L1, the second length L2, and the third length L3 are not equal to one another, but the present disclosure is not limited thereto.

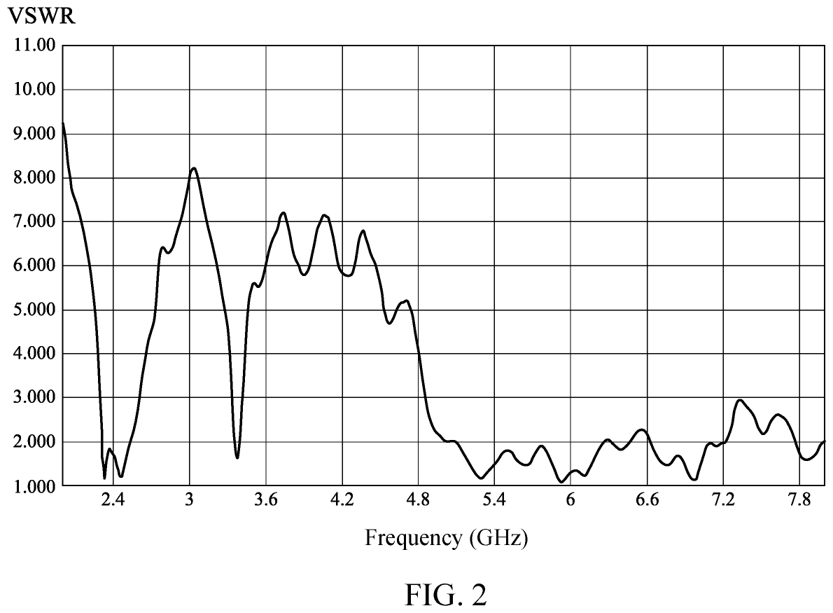

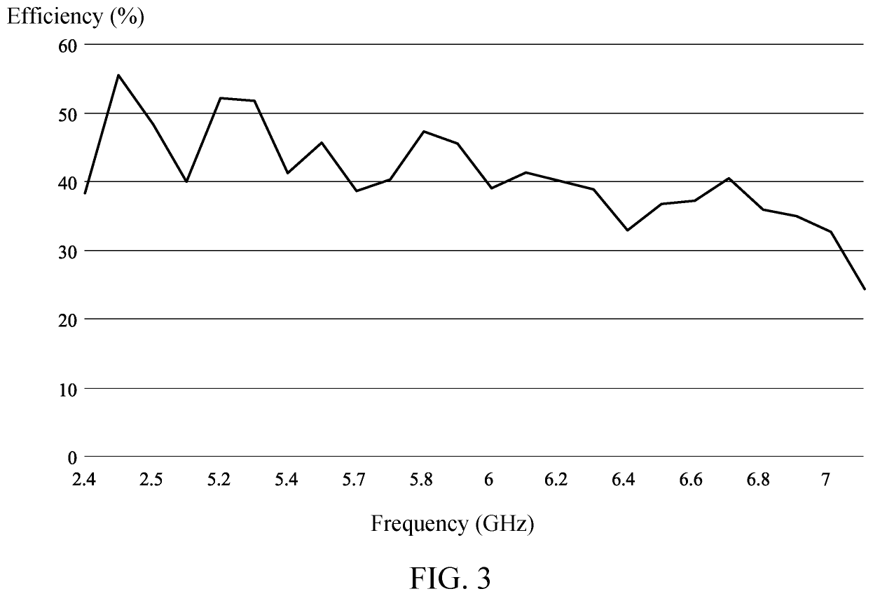

Referring to FIG. 1 to FIG. 3, FIG. 2 is a voltage standing wave ratio (VSWR) graph of the slot antenna structure 100 shown in FIG. 1. FIG. 3 is a schematic graph illustrating an efficiency of the slot antenna structure 100 shown in FIG. 1. The VSWR graph of the slot antenna structure 100 corresponding to different frequencies is shown in FIG. 2, and better quality signals are received when the VSWR is less than 2. A resonance frequency of the first slot 121 is between 6.2 GHz and 7.1 GHz. A resonance frequency of the second slot 122 is between 5.1 GHz and 6.1 GHz. A resonance frequency of the third slot 123 is between 2.4 GHz and 2.5 GHz.

As shown in FIG. 2, the VSWR of the slot antenna structure 100 is less than 2 at frequencies between 2.4 GHz and 2.5 GHz, 5.1 GHz and 6.1 GHz, and 6.7 GHz and 7.1 GHz, and is just slightly over 2 in the frequency range of 6.2 GHz to 6.7 GHz, and so signals having better quality can be received in the abovementioned frequency ranges. As shown in FIG. 3, the efficiency of the slot antenna structure 100 according to the present disclosure is above 30% in the abovementioned frequency ranges. In particular, the efficiency of the slot antenna structure 100 is even higher than 40% in the frequency ranges of 2.4 GHz to 2.5 GHz and 5.1 GHz to 5.9 GHz.

The first length L1 is greater than or equal to one quarter of a wavelength of a resonance frequency of the first slot 121 and less than or equal to three quarters of the wavelength of the resonance frequency of the first slot 121. The second length L2 is greater than or equal to one quarter of a wavelength of a resonance frequency of the second slot 122 and less than or equal to one half of the wavelength of the resonance frequency of the second slot 122. The third length L3 is greater than or equal to one quarter of a wavelength of a resonance frequency of the third slot 123 and less than or equal to one half of the wavelength of the resonance frequency of the third slot 123.

Therefore, by configuring the metal unit 120 to have three closed slots, namely the first slot 121, the second slot 122, and the third slot 123, the slot antenna structure 100 of the present disclosure is able to excite signals with resonance frequencies ranging from 2.4 GHz to 2.5 GHz, 5.1 GHz to 6.1 GHz, and 6.2 GHz to 7.1 GHz.

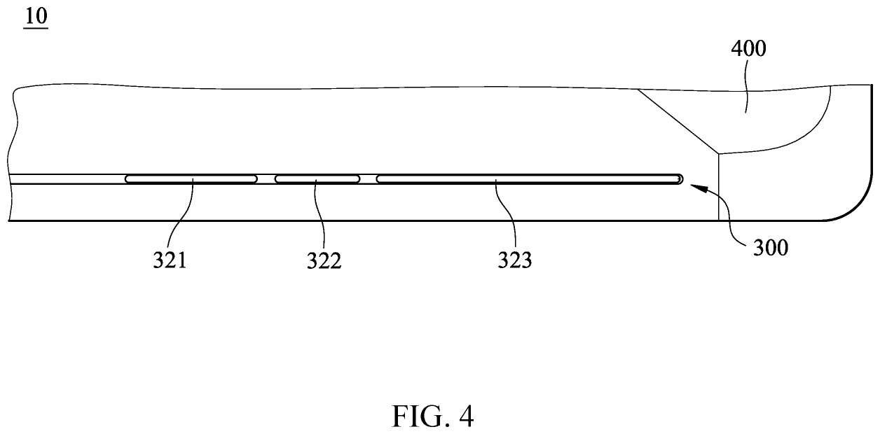

Referring to FIG. 1 and FIG. 4, FIG. 4 is a schematic view of an electronic device 10 according to a second embodiment of the present disclosure. The electronic device 10 includes a housing 400 and a slot antenna structure 300. The slot antenna structure 300 is disposed in the housing 400 and includes an antenna unit and a metal unit (the antenna unit 110 and the metal unit 120 shown in FIG. 1). The metal unit is electrically connected to the antenna unit and includes a first slot 321, a second slot 322, and a third slot 323. In this embodiment, the slot antenna structure 300 is similar to the slot antenna structure 100 of the first embodiment and will not be described herein. The electronic device 10 can be a laptop computer, a personal digital assistant, or other portable electronic devices, and the present disclosure is not limited thereby. More particularly, the antenna unit can be disposed on the circuit board (not shown) inside the housing 400 of the electronic device 10, and the metal unit can be disposed on the surface of the housing 400, such as the case A or A plane/side of a laptop computer, but the present disclosure is not limited thereto.

Hence, the slot antenna structure 300 is completely embedded into the housing 400, and so the electronic device 10 of the present disclosure is able to achieve the dual-band transmission and reception functions with the wireless communication device.

In view of the above, the present disclosure has the following advantages. First, the slot antenna structure of the present disclosure is able to excite transmission signals in multiple frequency bands by using three slots (first slot, second slot, and third slot). Second, by reducing the width of the slot to 1 mm and the length of the metal unit (sum of first length, second length, third length, first distance, and second distance) to 80 mm, the slot antenna structure of the present disclosure is able to excite transmission signals in multiple frequency bands with a reduced overall size of the slot antenna structure. Third, by configuring the metal unit to have three closed slots (first slot, second slot, and third slot), the slot antenna structure of the present disclosure is able to excite signals whose resonance frequencies range from 2.4 GHz to 2.5 GHz, 5.1 GHz to 6.1 GHz, and 6.2 GHz to 7.1 GHz. Fourth, by embedding the slot antenna structure completely into the housing, the electronic device of the present disclosure is able to transmit and receive data in dual frequency bands with the wireless communication device.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A slot antenna structure comprising:
an antenna unit; and
a metal unit electrically connected to the antenna unit and comprising:
a first slot having a first length along a direction;
a second slot having a second length along the direction and spaced a first distance apart from the first slot; and
a third slot having a third length along the direction and spaced a second distance apart from the second slot;
wherein the first slot, the second slot, and the third slot are arranged along the direction in sequence, the first length is greater than the second length, and the third length is greater than the first length.

2. The slot antenna structure according to claim 1, wherein the first distance and the second distance are each greater than or equal to 1 mm and less than or equal to 3 mm.

3. The slot antenna structure according to claim 1, wherein the first length is greater than or equal to 16 mm and less than or equal to 20 mm, the second length is greater than or equal to 11 mm and less than or equal to 15 mm, and the third length is greater than or equal to 43 mm and less than or equal to 47 mm.

4. The slot antenna structure according to claim 1, wherein a resonance frequency of the first slot is between 6.2 GHz and 7.1 GHz, a resonance frequency of the second slot is between 5.1 GHz and 6.1 GHz, and a resonance frequency of the third slot is between 2.4 GHz and 2.5 GHz.

5. The slot antenna structure according to claim 1, wherein the first length is greater than or equal to one quarter of a wavelength of a resonance frequency of the first slot and less than or equal to three quarters of the wavelength of the resonance frequency of the first slot, the second length is greater than or equal to one quarter of a wavelength of a resonance frequency of the second slot and less than or equal to one half of the wavelength of the resonance frequency of the second slot, and the third length is greater than or equal to one quarter of a wavelength of a resonance frequency of the third slot and less than or equal to one half of the wavelength of the resonance frequency of the third slot.

6. The slot antenna structure according to claim 1, wherein a width of the first slot, a width of the second slot, and a width of the third slot are each less than 2 mm.

7. The slot antenna structure according to claim 1, further comprising a feeding point disposed on the antenna unit, wherein a position of the feeding point corresponds to the third slot.

8. The slot antenna structure according to claim 1, wherein a sum of the first length, the second length, the third length, the first distance, and the second distance is less than or equal to 84 mm.

9. A slot antenna structure comprising:
an antenna unit; and
a metal unit electrically connected to the antenna unit and comprising:
a first slot having a first length along a direction;
a second slot having a second length along the direction and spaced a first distance apart from the first slot; and
a third slot having a third length along the direction and spaced a second distance apart from the second slot;
wherein the first slot, the second slot, and the third slot are arranged along the direction in sequence, any one of the first slot, the second slot, and the third slot is a closed slot, and the first length, the second length, and the third length are different.

10. The slot antenna structure according to claim 9, wherein the first distance and the second distance are each greater than or equal to 1 mm and less than or equal to 2 mm.

11. The slot antenna structure according to claim 9, wherein the first length is greater than or equal to 16 mm and less than or equal to 20 mm, the second length is greater than or equal to 11 mm and less than or equal to 15 mm, and the third length is greater than or equal to 43 mm and less than or equal to 47 mm.

12. The slot antenna structure according to claim 9, wherein a resonance frequency of the first slot is between 6.2 GHz and 7.1 GHz, a resonance frequency of the second slot is between 5.1 GHz and 6.1 GHz, and a resonance frequency of the third slot is between 2.4 GHz and 2.5 GHz.

13. The slot antenna structure according to claim 9, wherein the first length is greater than or equal to one quarter of a wavelength of a resonance frequency of the first slot and less than or equal to three quarters of the wavelength of the resonance frequency of the first slot, the second length is greater than or equal to one quarter of a wavelength of a resonance frequency of the second slot and less than or equal to one half of the wavelength of the resonance frequency of the second slot, and the third length is greater than or equal to one quarter of a wavelength of a resonance frequency of the third slot and less than or equal to one half of the wavelength of the resonance frequency of the third slot.

14. The slot antenna structure according to claim 9, wherein a width of the first slot, a width of the second slot, and a width of the third slot are each less than 2 mm.

15. The slot antenna structure according to claim 9, further comprising a feeding point disposed on the antenna unit, wherein a position of the feeding point corresponds to the third slot.

16. The slot antenna structure according to claim 9, wherein a sum of the first length, the second length, the third length, the first distance, and the second distance is less than or equal to 84 mm.

17. An electronic device comprising:
a housing; and
a slot antenna structure disposed in the housing and comprising:
an antenna unit; and
a metal unit electrically connected to the antenna unit and comprising:
a first slot having a first length along a direction;
a second slot having a second length along the direction and spaced a first distance apart from the first slot; and
a third slot having a third length along the direction and spaced a second distance apart from the second slot;
wherein the first slot, the second slot, and the third slot are arranged along the direction in sequence, any one of the first slot, the second slot, and the third slot is a closed slot, the first length is greater than the second length, and the third length is greater than the first length.

18. The electronic device according to claim 17, wherein a width of the first slot, a width of the second slot, and a width of the third slot are each 1 mm.
